(19) United States
(12) Patent Application Publication
(10) Pub. No.: US 2024/0267913 A1
(43) Pub. Date: Aug. 8, 2024

(54) METHOD AND DEVICE IN NODES USED FOR WIRELESS COMMUNICATION

(71) Applicants: Yang HU, Shanghai (CN); Xiaobo ZHANG, Shanghai (CN)

(72) Inventors: Yang HU, Shanghai (CN); Xiaobo ZHANG, Shanghai (CN)

(73) Assignee: SHANGHAI LANGBO COMMUNICATION TECHNOLOGY COMPANY LIMITED, Shanghai, OT (CN)

(21) Appl. No.: 18/427,785

(22) Filed: Jan. 30, 2024

(30) Foreign Application Priority Data
Feb. 3, 2023 (CN) 202310088959.4

(51) Int. Cl. H04W 72/1268; H04B 7/06; H04L 1/1812; H04W 72/21

(52) U.S. Cl. CPC H04W 72/1268; H04B 7/0626; H04L 1/1812; H04W 72/21

(57) ABSTRACT

The present application provides a method and device in a node for wireless communications. A first receiver receives at least one signaling; a first transmitter transmits a first UCI on a target PUSCH, the target PUSCH is one of multiple PUSCHs; the target PUSCH depends on reference information corresponding to the multiple PUSCHs, and the reference information comprises at least one of a coresetPoolIndex, an MCS index, or a frequency-domain resource allocation; herein, each PUSCH among the multiple PUSCHs is scheduled by one of the at least one signaling.

### CROSS REFERENCE TO RELATED APPLICATIONS

This application claims the priority benefit of Chinese patent application Ser. No. 202310088959.4, filed on Feb. 3, 2023, the full disclosure of which is incorporated herein by reference.

### BACKGROUND

### Technical Field

The present application relates to transmission methods and devices in wireless communication systems, and in particular to a transmission method and device of a radio signal in a wireless communication system supporting cellular networks.

### Related Art

In wireless communications, the multiplexing of UCI (Uplink control information) on a PUSCH (Physical uplink shared channel) is an important aspect of uplink transmission design.

### SUMMARY

In scenarios of transmission of multiple PUSCHs, clarifying on which PUSCH the UCI is transmitted is a critical issue that must be addressed; the present application discloses a solution to the above problem. The present application can be applied to a variety of wireless communication scenarios, such as single TRP (Transmit/Receive Point) communication, multi-TRP communication, eMBB (Enhanced Mobile Broadband), URLLC (Ultra Reliable and Low Latency Communication), MBS (Multicast Broadcast Services), IoT (Internet of Things), Internet of Vehicles, NTN (non-terrestrial networks), and shared spectrum, etc., where similar technical effects can be achieved. In addition, the adoption of a unified solution in different scenarios (including but not limited to single TRP communication, multi-TRP communication, eMBB, URLLC, MBS, IoT, IoV, NTN, shared spectrum) also helps to reduce hardware complexity and cost, or improve performance. If no conflict is incurred, embodiments in any node in the present application and the characteristics of the embodiments are also applicable to any other node, and vice versa. And the embodiments in the present application and the characteristics in the embodiments can be arbitrarily combined if there is no conflict.

In one embodiment, interpretations of the terminology in the present application refer to definitions given in the 3GPP TS36 series.

In one embodiment, interpretations of the terminology in the present application refer to definitions given in the 3GPP TS38 series.

In one embodiment, interpretations of the terminology in the present application refer to definitions given in the 3GPP TS37 series.

In one embodiment, interpretations of the terminology in the present application refer to definitions given in Institute of Electrical and Electronics Engineers (IEEE) protocol specifications.

The present application provides a method in a first node for wireless communications, comprising:
receiving at least one signaling; and
transmitting a first UCI on a target PUSCH, the target PUSCH being one of multiple PUSCHs; the target PUSCH depending on reference information corresponding to the multiple PUSCHs, the reference information comprising at least one of a coresetPoolIndex, an MCS index, or a frequency-domain resource allocation;
herein, each PUSCH among the multiple PUSCHs is scheduled by one of the at least one signaling.

In one embodiment, advantages of the above method comprise: increasing the uplink transmission performance.

In one embodiment, advantages of the above method comprise: improving the transmission reliability of UCI.

In one embodiment, advantages of the above method comprise: improving the system resource utilization and increasing the system performance.

In one embodiment, advantages of the above method comprise: increasing the scheduling flexibility.

In one embodiment, advantages of the above method comprise: avoiding inconsistent understanding between communication parties regarding to which PUSCH the UCI is multiplexed.

In one embodiment, advantages of the above method comprise: good compatibility.

In one embodiment, advantages of the above method comprise: changes to the existing 3GPP standard are minimal, and the workload required for standardization is minimal.

According to one aspect of the present application, the above method is characterized in that
only if none of the multiple PUSCHs are used to multiplex an aperiodic CSI, the target PUSCH depends on reference information corresponding to the multiple PUSCHs.

In one embodiment, advantages of the above method comprise: increasing the transmission performance of UCI.

In one embodiment, advantages of the above method comprise: good compatibility.

According to one aspect of the present application, the above method is characterized in that
all PUSCHs that have an overlapping with a PUCCH (Physical uplink control channel) carrying a UCI are selected as candidate PUSCHs, and any of the multiple PUSCHs is the candidate PUSCH.

According to one aspect of the present application, the above method is characterized in that
there exists at least one PUSCH corresponding to a control resource set (CORESET) pool index with a value of 0 among the multiple PUSCHs and there exists at least one PUSCH corresponding to a coresetPoolIndex with a value of 1, and the target PUSCH is a PUSCH corresponding to a coresetPoolIndex with a value of 0 among the multiple PUSCHs.

In one embodiment, advantages of the above method comprise: improving the transmission reliability of UCI.

In one embodiment, advantages of the above method comprise: simply and effectively specifying to which PUSCH the UCI is multiplexed.

According to one aspect of the present application, the above method is characterized in that
there exists at least one PUSCH corresponding to a coresetPoolIndex with a value of 0 and there exists at least one PUSCH corresponding to a coresetPoolIndex with a value of 1 among the multiple PUSCHs, and the target PUSCH is a PUSCH corresponding to a coresetPoolIndex with a value of 1 among the multiple PUSCHs.

In one embodiment, advantages of the above method comprise: improving the transmission reliability of UCI.

In one embodiment, advantages of the above method comprise: simply and effectively specifying to which PUSCH the UCI is multiplexed.

According to one aspect of the present application, the above method is characterized in that
there exists at least one PUSCH corresponding to a coresetPoolIndex with a value of 0 and there exists at least one PUSCH corresponding to a coresetPoolIndex with a value of 1 among the multiple PUSCHs, the target PUSCH is a PUSCH corresponding to a coresetPoolIndex with a value of k among the multiple PUSCHs, and k is a value of a coresetPoolIndex corresponding to a first PUCCH, k is one of 0 or 1.

In one embodiment, advantages of the above method comprise: increasing the transmission performance of UCI.

In one embodiment, advantages of the above method comprise: being beneficial to implement the dynamic selection of a PUSCH used for multiplexing a UCI, thus improving the uplink transmission performance.

According to one aspect of the present application, the above method is characterized in that
the target PUSCH is a PUSCH adopting a maximum MCS index among the multiple PUSCHs.

In one embodiment, advantages of the above method comprise: increasing the transmission performance of UCI.

In one embodiment, advantages of the above method comprise: simply and effectively specifying to which PUSCH the UCI is multiplexed.

According to one aspect of the present application, the above method is characterized in comprising:
receiving a first Physical downlink shared channel (PDSCH);
herein, the first UCI comprises HARQ-ACK information for a transmission block in the first PDSCH.

The present application provides a method in a second node for wireless communications, comprising:
transmitting at least one signaling; and
receiving a first UCI on a target PUSCH, the target PUSCH being one of multiple PUSCHs; the target PUSCH depending on reference information corresponding to the multiple PUSCHs, the reference information comprising at least one of a coresetPoolIndex, an MCS index, or a frequency-domain resource allocation;
herein, each PUSCH among the multiple PUSCHs is scheduled by one of the at least one signaling.

According to one aspect of the present application, the above method is characterized in that
only if none of the multiple PUSCHs are used to multiplex an aperiodic CSI, the target PUSCH depends on reference information corresponding to the multiple PUSCHs.

According to one aspect of the present application, the above method is characterized in that
all PUSCHs overlapping with a PUCCH carrying a UCI are selected as candidate PUSCHs, and any of the multiple PUSCHs is the candidate PUSCH.

According to one aspect of the present application, the above method is characterized in that
there exists at least one PUSCH corresponding to a coresetPoolIndex with a value of 0 and there exists at least one PUSCH corresponding to a coresetPoolIndex with a value of 1 among the multiple PUSCHs, and the target PUSCH is a PUSCH corresponding to a coresetPoolIndex with a value of 0 among the multiple PUSCHs.

According to one aspect of the present application, the above method is characterized in that
there exists at least one PUSCH corresponding to a coresetPoolIndex with a value of 0 and there exists at least one PUSCH corresponding to a coresetPoolIndex with a value of 1 among the multiple PUSCHs, and the target PUSCH is a PUSCH corresponding to a coresetPoolIndex with a value of 1 among the multiple PUSCHs.

According to one aspect of the present application, the above method is characterized in that
there exists at least one PUSCH corresponding to a coresetPoolIndex with a value of 0 and there exists at least one PUSCH corresponding to a coresetPoolIndex with a value of 1 among the multiple PUSCHs, the target PUSCH is a PUSCH corresponding to a coresetPoolIndex with a value of k among the multiple PUSCHs, and k is a value of a coresetPoolIndex corresponding to a first PUCCH, k is one of 0 or 1.

According to one aspect of the present application, the above method is characterized in that
the target PUSCH is a PUSCH adopting a maximum MCS index among the multiple PUSCHs.

According to one aspect of the present application, the above method is characterized in comprising:
transmitting a first PDSCH;
herein, the first UCI comprises HARQ-ACK information for a transmission block in the first PDSCH.

The present application provides a first node for wireless communications, comprising:
a first receiver, receiving at least one signaling; and
a first transmitter, transmitting a first UCI on a target PUSCH, the target PUSCH being one of multiple PUSCHs; the target PUSCH depending on reference information corresponding to the multiple PUSCHs, the reference information comprising at least one of a coresetPoolIndex, an MCS index, or a frequency-domain resource allocation;
herein, each PUSCH among the multiple PUSCHs is scheduled by one of the at least one signaling.

The present application provides a second node for wireless communications, comprising:
a second transmitter, transmitting at least one signaling; and
a second receiver, receiving a first UCI on a target PUSCH, the target PUSCH being one of multiple PUSCHs; the target PUSCH depending on reference information corresponding to the multiple PUSCHs, the reference information comprising at least one of a coresetPoolIndex, an MCS index, or a frequency-domain resource allocation;
herein, each PUSCH among the multiple PUSCHs is scheduled by one of the at least one signaling.

The present application provides a method in a first node for wireless communications, comprising:
receiving at least one signaling; and
transmitting a first UCI on a target PUSCH, the target PUSCH being one of multiple PUSCHs; when one of the multiple PUSCHs is used for multiplexing an aperiodic CSI, the target PUSCH being the PUSCH used for multiplexing an aperiodic CSI; when the multiple PUSCHs are not used for multiplexing an aperiodic CSI, the target PUSCH depending on reference information corresponding to the multiple PUSCHs, the reference information comprising at least one of a coresetPoolIndex, an MCS index, or a frequency-domain resource allocation;
herein, each PUSCH among the multiple PUSCHs is scheduled by one of the at least one signaling.

In one embodiment, advantages of the above method comprise: increasing the uplink transmission performance.

In one embodiment, advantages of the above method comprise: improving the transmission reliability of UCI.

In one embodiment, advantages of the above method comprise: improving the system resource utilization and increasing the system performance.

In one embodiment, advantages of the above method comprise: increasing the scheduling flexibility.

In one embodiment, advantages of the above method comprise: avoiding inconsistent understanding between communication parties regarding to which PUSCH the UCI is multiplexed.

In one embodiment, advantages of the above method comprise: good compatibility.

In one embodiment, advantages of the above method comprise: changes to the existing 3GPP standard are minimal, and the workload required for standardization is minimal.

According to one aspect of the present application, the above method is characterized in that

all PUSCHs overlapping with a PUCCH carrying a UCI are selected as candidate PUSCHs, and any of the multiple PUSCHs is the candidate PUSCH.

According to one aspect of the present application, the above method is characterized in that
there exists at least one PUSCH corresponding to a coresetPoolIndex with a value of 0 and there exists at least one PUSCH corresponding to a coresetPoolIndex with a value of 1 among the multiple PUSCHs; when the multiple PUSCHs are not used to multiplex an aperiodic CSI, the target PUSCH is a PUSCH corresponding to a coresetPoolIndex with a value of 0 among the multiple PUSCHs.

In one embodiment, advantages of the above method comprise: improving the transmission reliability of UCI.

In one embodiment, advantages of the above method comprise: simply and effectively specifying to which PUSCH the UCI is multiplexed.

According to one aspect of the present application, the above method is characterized in that
there exists at least one PUSCH corresponding to a coresetPoolIndex with a value of 0 and there exists at least one PUSCH corresponding to a coresetPoolIndex with a value of 1 among the multiple PUSCHs; when the multiple PUSCHs are not used to multiplex an aperiodic CSI, the target PUSCH is a PUSCH corresponding to a coresetPoolIndex with a value of 1 among the multiple PUSCHs.

In one embodiment, advantages of the above method comprise: improving the transmission reliability of UCI.

In one embodiment, advantages of the above method comprise: simply and effectively specifying to which PUSCH the UCI is multiplexed.

According to one aspect of the present application, the above method is characterized in that
there exists at least one PUSCH corresponding to a coresetPoolIndex with a value of 0 and there exists at least one PUSCH corresponding to a coresetPoolIndex with a value of 1 among the multiple PUSCHs; when the multiple PUSCHs are not used for multiplexing an aperiodic CSI, the target PUSCH is a PUSCH corresponding to a coresetPoolIndex with a value of k among the multiple PUSCHs, where k is a value of a coresetPoolIndex corresponding to a first PUCCH, and k is one of 0 or 1.

In one embodiment, advantages of the above method comprise: increasing the transmission performance of UCI.

In one embodiment, advantages of the above method comprise: being beneficial to implement the dynamic selection of a PUSCH used for multiplexing a UCI, which improves the uplink transmission performance.

According to one aspect of the present application, the above method is characterized in that
when the multiple PUSCHs are not used for multiplexing an aperiodic CSI, the target PUSCH is a PUSCH that uses a maximum MCS index among the multiple PUSCHs.

In one embodiment, advantages of the above method comprise: increasing the transmission performance of UCI.

In one embodiment, advantages of the above method comprise: simply and effectively specifying to which PUSCH the UCI is multiplexed.

According to one aspect of the present application, the above method is characterized in comprising:
receiving a first PDSCH;
herein, the first UCI comprises HARQ-ACK information for a transmission block in the first PDSCH.

The present application provides a method in a second node for wireless communications, comprising:
transmitting at least one signaling; and
receiving a first UCI on a target PUSCH, the target PUSCH being one of multiple PUSCHs; when one of the multiple PUSCHs is used for multiplexing an aperiodic CSI, the target PUSCH being the PUSCH used for multiplexing an aperiodic CSI; when the multiple PUSCHs are not used for multiplexing an aperiodic CSI, the target PUSCH depending on reference information corresponding to the multiple PUSCHs, the reference information comprising at least one of a coresetPoolIndex, an MCS index, or a frequency-domain resource allocation;
herein, each PUSCH among the multiple PUSCHs is scheduled by one of the at least one signaling.

According to one aspect of the present application, the above method is characterized in that
all PUSCHs overlapping with a PUCCH carrying a UCI are selected as candidate PUSCHs, and any of the multiple PUSCHs is the candidate PUSCH.

According to one aspect of the present application, the above method is characterized in that
there exists at least one PUSCH corresponding to a coresetPoolIndex with a value of 0 and there exists at least one PUSCH corresponding to a coresetPoolIndex with a value of 1 among the multiple PUSCHs; when the multiple PUSCHs are not used to multiplex an aperiodic CSI, the target PUSCH is a PUSCH corresponding to a coresetPoolIndex with a value of 0 among the multiple PUSCHs.

According to one aspect of the present application, the above method is characterized in that
there exists at least one PUSCH corresponding to a coresetPoolIndex with a value of 0 and there exists at least one PUSCH corresponding to a coresetPoolIndex with a value of 1 among the multiple PUSCHs; when the multiple PUSCHs are not used to multiplex an aperiodic CSI, the target PUSCH is a PUSCH corresponding to a coresetPoolIndex with a value of 1 among the multiple PUSCHs.

According to one aspect of the present application, the above method is characterized in that
there exists at least one PUSCH corresponding to a coresetPoolIndex with a value of 0 and there exists at least one PUSCH corresponding to a coresetPoolIndex with a value of 1 among the multiple PUSCHs; when the multiple PUSCHs are not used for multiplexing an aperiodic CSI, the target PUSCH is a PUSCH corresponding to a coresetPoolIndex with a value of k among the multiple PUSCHs, where k is a value of a coresetPoolIndex corresponding to a first PUCCH, and k is one of 0 or 1.

According to one aspect of the present application, the above method is characterized in that
when the multiple PUSCHs are not used for multiplexing an aperiodic CSI, the target PUSCH is a PUSCH that uses a maximum MCS index among the multiple PUSCHs.

According to one aspect of the present application, the above method is characterized in comprising:
transmitting a first PDSCH;
herein, the first UCI comprises HARQ-ACK information for a transmission block in the first PDSCH.

The present application provides a first node for wireless communications, comprising:
a first receiver, receiving at least one signaling; and
a first transmitter, transmitting a first UCI on a target PUSCH, the target PUSCH being one of multiple PUSCHs; when one of the multiple PUSCHs is used for multiplexing an aperiodic CSI, the target PUSCH being the PUSCH used for multiplexing an aperiodic CSI; when the multiple PUSCHs are not used for multiplexing an aperiodic CSI, the target PUSCH depending on reference information corresponding to the multiple PUSCHs, the reference information comprising at least one of a coresetPoolIndex, an MCS index, or a frequency-domain resource allocation;
herein, each PUSCH among the multiple PUSCHs is scheduled by one of the at least one signaling.

The present application provides a second node for wireless communications, comprising:
a second transmitter, transmitting at least one signaling; and
a second receiver, receiving a first UCI on a target PUSCH, the target PUSCH being one of multiple PUSCHs; when one of the multiple PUSCHs is used for multiplexing an aperiodic CSI, the target PUSCH being the PUSCH used for multiplexing an aperiodic CSI; when the multiple PUSCHs are not used for multiplexing an aperiodic CSI, the target PUSCH depending on reference information corresponding to the multiple PUSCHs, the reference information comprising at least one of a coresetPoolIndex, an MCS index, or a frequency-domain resource allocation;
herein, each PUSCH among the multiple PUSCHs is scheduled by one of the at least one signaling.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of the processing of a first node according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5 illustrates a flowchart of signal transmission according to one embodiment of the present application;

FIG. 6 illustrates a schematic diagram of a target PUSCH according to one embodiment of the present application;

FIG. 7 illustrates a schematic diagram of multiple PUSCHs according to one embodiment of the present application;

FIG. 8 illustrates a schematic diagram of a target PUSCH according to one embodiment of the present application;

FIG. 9 illustrates a schematic diagram of a target PUSCH according to one embodiment of the present application;

FIG. 10 illustrates a structure block diagram of a processor in a first node according to one embodiment of the present application;

FIG. 11 illustrates a structure block diagram of a processor in second node according to one embodiment of the present application.

### DESCRIPTION OF THE EMBODIMENTS

The technical solution of the present application will be further described in detail below in combination with the drawings. It should be noted that, in the case of no conflict, the embodiments of the present application and the features in the embodiments may be combined with each other arbitrarily.

### Embodiment 1

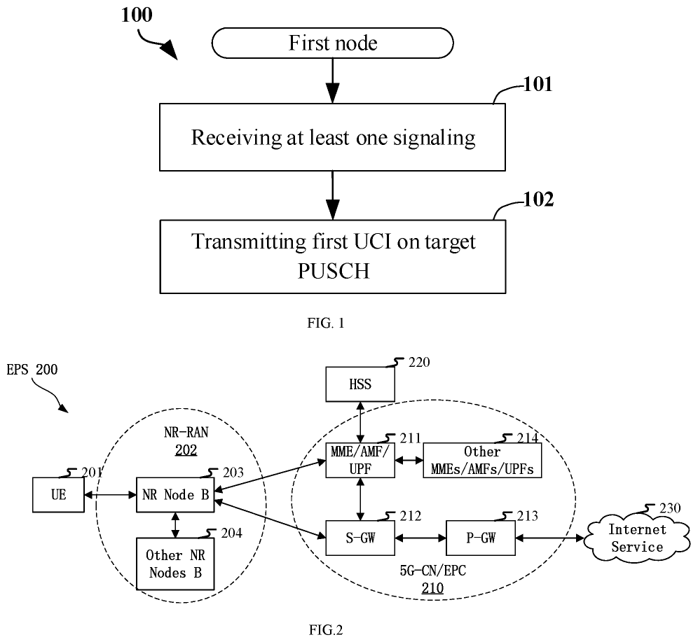

Embodiment 1 illustrates a flowchart of processing of a first node according to one embodiment of the present application, as shown in FIG. 1.

In Embodiment 1, the first node in the present application receives at least one signaling in step 101; transmits a first UCI on a target PUSCH in step 102;

In embodiment 1, the target PUSCH is one of multiple PUSCHs; the target PUSCH depends on reference information corresponding to the multiple PUSCHs, and the reference information comprises at least one of a coresetPoolIndex, an MCS index, or a frequency-domain resource allocation; each PUSCH among the multiple PUSCHs is scheduled by one of the at least one signaling.

In one embodiment, the at least one signaling only comprises one signaling.

In one embodiment, the at least one signaling comprises multiple signalings.

In one embodiment, each signaling in the at least one signaling is an UpLink Grant Signalling.

In one embodiment, each signaling in the at least one signaling is Downlink control information (DCI).

In one embodiment, each signaling in the at least one signaling is a DCI format.

In one embodiment, each signaling in the at least one signaling is detected in a Physical downlink control channel (PDCCH).

In one embodiment, a signaling in the at least one signaling is a DCI.

In one embodiment, a signaling in the at least one signaling is a physical-layer signaling.

In one embodiment, a signaling in the at least one signaling is an RRC signaling.

In one embodiment, a signaling in the at least one signaling is a MAC CE.

In one embodiment, each signaling in the at least one signaling comprises a DCI.

In one embodiment, each signaling in the at least one signaling comprises a DCI format.

In one embodiment, one of the at least one signaling comprises a DCI.

In one embodiment, one of the at least one signaling comprises a physical-layer signaling.

In one embodiment, one of the at least one signaling comprises an RRC signaling.

In one embodiment, one of the at least one signaling comprises a MAC CE.

In one embodiment, one of the at least one signaling comprises at least one field in a DCI format.

In one embodiment, an index of a CORESET set pool for a CORESET used to receive one signaling in the at least one signal is 0, and an index of a CORESET set pool for a CORESET used to receive another signaling in the at least one signal is 1.

In one embodiment, an index of a CORESET set pool for a CORESET used to monitor one signaling in the at least one signal is 0, and an index of a CORESET set pool for a CORESET used to monitor another signaling in the at least one signal is 1.

In one embodiment, the meaning of the expression in the present application of transmitting a first UCI on a target PUSCH comprises: the first UCI is multiplexed onto the target PUSCH.

In one embodiment, the meaning of the expression in the present application of transmitting a first UCI on a target PUSCH is: transmitting a target PUSCH, and the first UCI being multiplexed onto the target PUSCH.

In one embodiment, the meaning of the expression in the present application of transmitting a first UCI on a target PUSCH, and the target PUSCH being one of multiple PUSCHs is: transmitting a PUSCH used for multiplexing a first UCI, and the PUSCH used for multiplexing the first UCI being one of multiple PUSCHs.

In one embodiment, the meaning of transmitting a PUSCH comprises: transmitting a signal in the PUSCH.

In one embodiment, the meaning of transmitting a PUSCH comprises: transmitting information through the PUSCH.

In one embodiment, the target PUSCH is used to transmit the first UCI and at least one transport block (TB).

In one embodiment, the multiple PUSCHs are two PUSCHs.

In one embodiment, the multiple PUSCHs comprise not less than two PUSCHs.

In one embodiment, the multiple PUSCHs comprise not less than three PUSCHs.

In one embodiment, the reference information corresponding to the multiple PUSCHs is used to determine the target PUSCH.

In one embodiment, the reference information corresponding to multiple PUSCHs is used together to indicate the target PUSCH.

In one embodiment, the reference information corresponding to the multiple PUSCHs is used to determine which PUSCH among the multiple PUSCHs the target PUSCH is.

In one embodiment, for any of the multiple PUSCHs, the corresponding reference information is a coresetPoolIndex.

In one embodiment, the reference information corresponding to any of the multiple PUSCHs is: a coresetPoolIndex for a CORESET associated with a PDCCH scheduling the PUSCH.

In one embodiment, a CORESET associated with a PDCCH is a CORESET configured to monitor at least the PDCCH.

In one embodiment, a CORESET associated with a PDCCH is a CORESET configured to monitor a DCI format in the at least the PDCCH.

In one embodiment, a CORESET associated with a PDCCH is used to determine resources occupied by this PDCCH.

In one embodiment, the reference information corresponding to any of the multiple PUSCHs is: scheduling an MCS index indicated by a DCI of this PUSCH.

In one embodiment, the reference information corresponding to any of the multiple PUSCHs is: scheduling frequency-domain resource allocation indicated by a DCI of this PUSCH.

In one embodiment, the reference information corresponding to any of the multiple PUSCHs is: an MCS (Modulation and Coding Scheme) index used for the PUSCH.

In one embodiment, the reference information corresponding to any of the multiple PUSCHs is: frequency-domain resource allocation used for the PUSCH.

In one embodiment, for any of the multiple PUSCHs, the corresponding reference information is a coresetPoolIndex and an MCS index.

In one embodiment, for any of the multiple PUSCHs, the corresponding reference information is a coresetPoolIndex and a frequency-domain resource allocation.

In one embodiment, for any of the multiple PUSCHs, the corresponding reference information is a coresetPoolIndex, an MCS index and a frequency-domain resource allocation.

In one embodiment, for any of the multiple PUSCHs, the corresponding reference information is an MCS index and a frequency-domain resource allocation.

In one embodiment, the meaning of the expression in the present application that the target PUSCH depends on reference information corresponding to the multiple PUSCHs, and the reference information comprises at least one of a coresetPoolIndex, an MCS index, or a frequency-domain resource allocation is:
there exists at least one PUSCH corresponding to a coresetPoolIndex with a value of 0 and there exists at least one PUSCH corresponding to a coresetPoolIndex with a value of 1 among the multiple PUSCHs, and the target PUSCH is a PUSCH corresponding to a coresetPoolIndex with a value of 0 among the multiple PUSCHs.

In one embodiment, the meaning of the expression in the present application that the target PUSCH depends on reference information corresponding to the multiple PUSCHs, and the reference information comprises at least one of a coresetPoolIndex, an MCS index, or a frequency-domain resource allocation is:
there exists at least one PUSCH corresponding to a coresetPoolIndex with a value of 0 and there exists at least one PUSCH corresponding to a coresetPoolIndex with a value of 1 among the multiple PUSCHs, and the target PUSCH is a PUSCH corresponding to a coresetPoolIndex with a value of 1 among the multiple PUSCHs.

In one embodiment, the meaning of the expression in the present application that the target PUSCH depends on reference information corresponding to the multiple PUSCHs, and the reference information comprises at least one of a coresetPoolIndex, an MCS index, or a frequency-domain resource allocation is:
there exists at least one PUSCH corresponding to a coresetPoolIndex with a value of 0 and there exists at least one PUSCH corresponding to a coresetPoolIndex with a value of 1 among the multiple PUSCHs, the target PUSCH is a PUSCH corresponding to a coresetPoolIndex with a value of k among the multiple PUSCHs, and k is a value of a coresetPoolIndex corresponding to a first PUCCH, k is one of 0 or 1.

In one embodiment, the meaning of the expression in the present application that the target PUSCH depends on reference information corresponding to the multiple PUSCHs, and the reference information comprises at least one of a coresetPoolIndex, an MCS index, or a frequency-domain resource allocation is:
there exists at least one PUSCH corresponding to a coresetPoolIndex with a value of 0 and there exists at least one PUSCH corresponding to a coresetPoolIndex with a value of 1 among the multiple PUSCHs, the target PUSCH is a PUSCH corresponding to a coresetPoolIndex with a value of k among the multiple PUSCHs, and k is a value of a coresetPoolIndex corresponding to a first PUCCH resource, k is one of 0 or 1.

In one embodiment, the meaning of the expression in the present application that the target PUSCH depends on reference information corresponding to the multiple PUSCHs, and the reference information comprises at least one of a coresetPoolIndex, an MCS index, or a frequency-domain resource allocation is: the target PUSCH is a PUSCH corresponding to a coresetPoolIndex with a value of 0 among the multiple PUSCHs.

In one embodiment, the meaning of the expression in the present application that the target PUSCH depends on reference information corresponding to the multiple PUSCHs, and the reference information comprises at least one of a coresetPoolIndex, an MCS index, or a frequency-domain resource allocation is: the target PUSCH is a PUSCH corresponding to a coresetPoolIndex with a value of 0 among the multiple PUSCHs.

In one embodiment, the meaning of the expression in the present application that the target PUSCH depends on reference information corresponding to the multiple PUSCHs, and the reference information comprises at least one of a coresetPoolIndex, an MCS index, or a frequency-domain resource allocation is: the target PUSCH is a PUSCH corresponding to a coresetPoolIndex with a value of k among the multiple PUSCHs, where k is a value of a coresetPoolIndex corresponding to a first PUCCH, and k is one of 0 or 1.

In one embodiment, the meaning of the expression in the present application that the target PUSCH depends on reference information corresponding to the multiple PUSCHs, and the reference information comprises at least one of a coresetPoolIndex, an MCS index, or a frequency-domain resource allocation is: the target PUSCH is a PUSCH corresponding to a coresetPoolIndex with a value of k among the multiple PUSCHs, where k is a value of a coresetPoolIndex corresponding to a first PUCCH resource, and k is one of 0 or 1.

In one embodiment, the meaning of the expression in the present application of the target PUSCH depending on reference information corresponding to the multiple PUSCHs is: the target PUSCH is which PUSCH among the multiple PUSCHs depends on the reference information corresponding to each PUSCH among the multiple PUSCHs.

In one embodiment, the target PUSCH is a PUSCH adopting a maximum MCS index among the multiple PUSCHs.

In one embodiment, the target PUSCH is a PUSCH adopting a minimum MCS among the multiple PUSCHs indexed.

In one embodiment, the target PUSCH is a PUSCH with a largest frequency-domain resource allocation number among the multiple PUSCHs.

In one embodiment, the target PUSCH is a PUSCH with a smallest frequency-domain resource allocation number among the multiple PUSCHs.

In one embodiment, the multiple PUSCHs overlap in time domain.

In one embodiment, the multiple PUSCHs fully overlap in time domain.

In one embodiment, at least 2 of the multiple PUSCHs overlap in time domain.

In one embodiment, two of the multiple PUSCHs only partially overlap in time domain.

In one embodiment, the multiple PUSCHs overlap in frequency domain.

In one embodiment, the multiple PUSCHs fully overlap in frequency domain.

In one embodiment, at least 2 of the multiple PUSCHs overlap in frequency domain.

In one embodiment, two of the multiple PUSCHs only partially overlap in frequency domain.

In one embodiment, at least 2 of the multiple PUSCHs do not overlap in frequency domain.

In one embodiment, only the target PUSCH of the multiple PUSCHs is used to multiplex the first UCI.

In one embodiment, the first UCI comprises HARQ-ACK (Hybrid automatic repeat request acknowledgement) information.

In one embodiment, the first UCI comprises Channel-State Information (CSI).

In one embodiment, the first UCI comprises a periodic CSI.

In one embodiment, the first UCI comprises a semi-persistent CSI.

In one embodiment, the first UCI is HARQ-ACK information.

In one embodiment, the first UCI is a CSI.

In one embodiment, the first UCI is a periodic CSI.

In one embodiment, the first UCI is a semi-persistent CSI.

In one embodiment, the multiple PUSCHs overlap with a same PUCCH.

In one embodiment, the at least one signaling only comprises one signaling.

In one embodiment, the at least one signaling is two signalings.

In one embodiment, the at least one signaling comprises more than two signalings.

In one embodiment, the at least one signaling respectively schedules the multiple PUSCHs.

In one embodiment, when none of the multiple PUSCHs are used to multiplex an aperiodic CSI, the target PUSCH depends on reference information corresponding to the multiple PUSCHs.

In one embodiment, when any of the multiple PUSCHs is not used to multiplex an aperiodic CSI, the target PUSCH depends on reference information corresponding to the multiple PUSCHs.

In one embodiment, the first node transmits each of the multiple PUSCHs.

In one embodiment, the first node executes signal transmission on each of the multiple PUSCHs.

### Embodiment 2

Embodiment 2 illustrates a schematic diagram of a network architecture according to the present application, as shown in FIG. 2.

FIG. 2 illustrates a network architecture 200 of 5G NR, Long-Term Evolution (LTE) and Long-Term Evolution Advanced (LTE-A) systems. The NR 5G or LTE network architecture 200 may be called an Evolved Packet System (EPS) 200 or other appropriate terms. The EPS 200 may comprise one or more UEs 201, an NG-RAN 202, an Evolved Packet Core/5G-Core Network (EPC/5G-CN) 210, a Home Subscriber Server (HSS) 220 and an Internet Service 230. The EPS 200 may be interconnected with other access networks. For simple description, the entities/interfaces are not shown. As shown in FIG. 2, the EPS 200 provides packet switching services. Those skilled in the art will readily understand that various concepts presented throughout the present application can be extended to networks providing circuit switching services or other cellular networks. The NG-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the EPC/5G-CN 210 for the UE 201. Examples of the UE 201 include cellular phones, smart phones, Session Initiation Protocol (SIP) phones, laptop computers, Personal Digital Assistant (PDA), satellite Radios, non-terrestrial base station communications, Satellite Mobile Communications, Global Positioning Systems (GPSs), multimedia devices, video devices, digital audio players (for example, MP3 players), cameras, game consoles, unmanned aerial vehicles (UAV), aircrafts, narrow-band Internet of Things (loT) devices, machine-type communication devices, land vehicles, automobiles, wearable devices, or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the EPC/5G-CN 210 via an S1/NG interface. The EPC/5G-CN 210 comprises a Mobility Management Entity (MME)/Authentication Management Field (AMF)/User Plane Function (UPF) 211, other MMEs/AMFs/UPFs 214, a Service Gateway (S-GW) 212 and a Packet Date Network Gateway (P-GW) 213. The MME/AMF/UPF 211 is a control node for processing a signaling between the UE 201 and the EPC/5G-CN 210. Generally, the MME/AMF/UPF 211 provides bearer and connection management. All user Internet Protocol (IP) packets are transmitted through the S-GW 212, the S-GW 212 is connected to the P-GW 213. The P-GW 213 provides UE IP address allocation and other functions. The P-GW 213 is connected to the Internet Service 230. The Internet Service 230 comprises IP services corresponding to operators, specifically including Internet, Intranet, IP Multimedia Subsystem (IMS) and Packet Switching Streaming Services (PSS).

In one embodiment, the UE 201 corresponds to the first node in the present application.

In one embodiment, the UE 201 corresponds to the second node in the present application.

In one embodiment, the UE 201 is a UE.

In one embodiment, the gNB 203 corresponds to the first node in the present application.

In one embodiment, the gNB 203 corresponds to the second node in the present application.

In one embodiment, the UE 201 corresponds to the first node in the present application, and the gNB 203 corresponds to the second node in the present application.

In one embodiment, the gNB 203 is a MarcoCellular base station.

In one embodiment, the gNB 203 is a Micro Cell base station.

In one embodiment, the gNB 203 is a PicoCell base station.

In one embodiment, the gNB 203 is a Femtocell.

In one embodiment, the gNB 203 is a base station that supports large delay differences.

In one embodiment, the gNB 203 is a flight platform.

In one embodiment, the gNB 203 is satellite equipment.

In one embodiment, the gNB 203 is a base station that enables network energy saving enhancement.

In one embodiment, both the first node and the second node in the present application correspond to the UE 201, for example, V2X communications are performed between the first node and the second node.

### Embodiment 3

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for a first communication node (UE, gNB or an RSU in V2X) and a second communication node (gNB, UE or an RSU in V2X), or between two UEs is represented by three layers, which are a layer 1, a layer 2 and a layer 3, respectively. The layer 1 (L1) is the lowest layer and performs signal processing functions of various PHY layers. The L1 is called PHY 301 in the present application. The layer 2 (L2) 305 is above the PHY 301, and is in charge of a link between a first communication node and a second communication node, as well as two UEs via the PHY 301. L2 305 comprises a Medium Access Control (MAC) sublayer 302, a Radio Link Control (RLC) sublayer 303 and a Packet Data Convergence Protocol (PDCP) sublayer 304. All the three sublayers terminate at the second communication node. The PDCP sublayer 304 provides multiplexing among variable radio bearers and logical channels. The PDCP sublayer 304 provides security by encrypting a packet and provides support for a first communication node handover between second communication nodes. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. The Radio Resource Control (RRC) sublayer 306 in layer 3 (L3) of the control plane 300 is responsible for acquiring radio resources (i.e., radio bearer) and configuring the lower layer with an RRC signaling between a second communication node and a first communication node device. The radio protocol architecture of the user plane 350 comprises layer 1 (L1) and layer 2 (L2). In the user plane 350, the radio protocol architecture for the first communication node and the second communication node is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. Although not described in FIG. 3, the first communication node may comprise several higher layers above the L2 layer 355, such as a network layer (e.g., IP layer) terminated at a P-GW of the network side and an application layer terminated at the other side of the connection (e.g., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, one of the at least one signaling in the present application is generated by the RRC sublayer 306.

In one embodiment, one of the at least one signaling in the present application is generated by the MAC sublayer 302.

In one embodiment, one of the at least one signaling in the present application is generated by the PHY 301.

### Embodiment 4

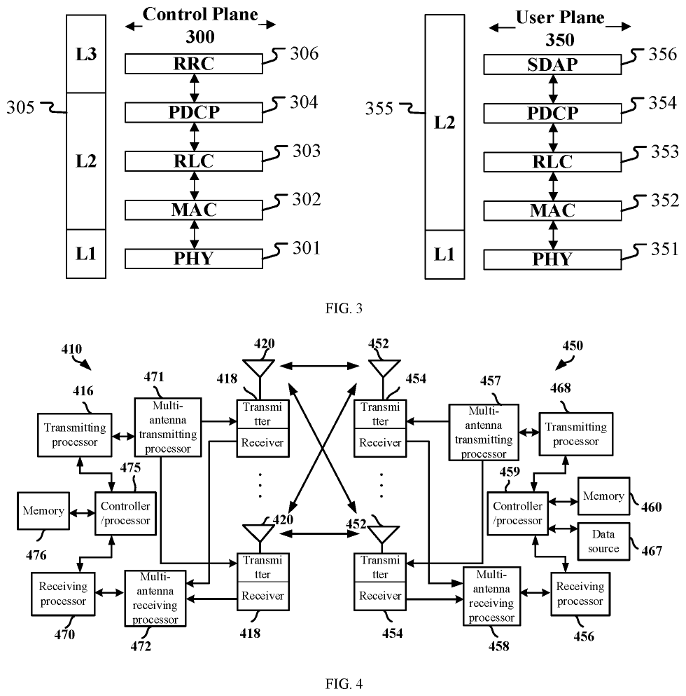

Embodiment 4 illustrates a schematic diagram of a first communication device and a second communication device in the present application, as shown in FIG. 4. FIG. 4 is a block diagram of a first communication device 410 in communication with a second communication device 450 in an access network.

The first communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

The second communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

In a transmission from the first communication device 410 to the second communication device 450, at the first communication device 410, a higher layer packet from the core network is provided to a controller/processor 475. The controller/processor 475 provides a function of the L2 layer. In the transmission from the first communication device 410 to the first communication device 450, the controller/processor 475 provides header compression, encryption, packet segmentation and reordering, and multiplexing between a logical channel and a transport channel, and radio resources allocation to the second communication device 450 based on various priorities. The controller/processor 475 is also responsible for retransmission of a lost packet and a signaling to the second communication device 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 450, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the first communication device 410 to the second communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any the second communication device-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted on the physical channel by the first communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In the transmission from the first communication device 410 to the second communication device 450, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing.

In a transmission from the second communication device 450 to the first communication device 410, at the second communication device 450, the data source 467 is configured to provide a higher-layer packet to the controller/processor 459. The data source 467 represents all protocol layers above the L2 layer. Similar to a transmitting function of the first communication device 410 described in the transmission from the first communication device 410 to the second communication device 450, the controller/processor 459 performs header compression, encryption, packet segmentation and reordering, and multiplexing between a logical channel and a transport channel based on radio resources allocation so as to provide the L2 layer functions used for the user plane and the control plane. The controller/processor 459 is also responsible for retransmission of a lost packet, and a signaling to the first communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the second communication device 450 to the first communication device 410, the function of the first communication device 410 is similar to the receiving function of the second communication device 450 described in the transmission from the first communication device 410 to the second communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. In the transmission from the second communication device 450 to the first communication device 410, the controller/processor 475 provides de-multiplexing between a transport channel and a logical channel, packet reassembling, decryption, header decompression, control signal processing so as to recover a higher-layer packet from the UE 450. The higher-layer packet coming from the controller/processor 475 may be provided to the core network.

In one embodiment, the first node in the present application comprises the second communication device 450, and the second node in the present application comprises the first communication device 410.

In one subembodiment of the above embodiment, the first node is a UE, and the second node is a UE.

In one subembodiment of the above embodiment, the first node is a UE, and the second node is a relay node.

In one subembodiment of the above embodiment, the first node is a relay node, and the second node is a UE.

In one subembodiment of the above embodiment, the first node is a UE, and the second node is a base station.

In one subembodiment of the above embodiment, the first node is a relay node, and the second node is a base station.

In one subembodiment of the above embodiment, the second node is a UE, and the first node is a base station.

In one subembodiment of the above embodiment, the second node is a relay node, and the first node is a base station.

In one subembodiment of the above embodiment, the second communication device 450 comprises: at least one controller/processor; the at least one controller/processor is responsible for HARQ operation.

In one subembodiment of the above embodiment, the first communication device 410 comprises: at least one controller/processor; the at least one controller/processor is responsible for HARQ operation.

In one subembodiment of the above embodiment, the first communication device 410 comprises: at least one controller/processor; the at least one controller/processor is responsible for error detection using ACK and/or NACK protocols as a way to support HARQ operation.

In one embodiment, the second communication device 450 comprises at least one processor and at least one memory. The at least one memory comprises computer program codes; the at least one memory and the computer program codes are configured to be used in collaboration with the at least one processor. The second communication device 450 at least: receives at least one signaling; transmits a first UCI on a target PUSCH, the target PUSCH is one of multiple PUSCHs; the target PUSCH depends on reference information corresponding to the multiple PUSCHs, and the reference information comprises at least one of a coresetPoolIndex, an MCS index, or a frequency-domain resource allocation; herein, each PUSCH among the multiple PUSCHs is scheduled by one of the at least one signaling.

In one subembodiment of the above embodiment, the second communication device 450 corresponds to the first node in the present application.

In one embodiment, the second communication device 450 comprises a memory that stores a computer readable instruction program. The computer readable instruction program generates an action when executed by at least one processor. The action includes: receiving at least one signaling; transmitting a first UCI on a target PUSCH, the target PUSCH being one of multiple PUSCHs; the target PUSCH depending on reference information corresponding to the multiple PUSCHs, the reference information comprising at least one of a coresetPoolIndex, an MCS index, or a frequency-domain resource allocation; herein, each PUSCH among the multiple PUSCHs is scheduled by one of the at least one signaling.

In one subembodiment of the above embodiment, the second communication device 450 corresponds to the first node in the present application.

In one embodiment, the first communication device 410 comprises at least one processor and at least one memory. The at least one memory comprises computer program codes; the at least one memory and the computer program codes are configured to be used in collaboration with the at least one processor. The first communication device 410 at least: transmits at least one signaling; receives a first UCI on a target PUSCH, the target PUSCH is one of multiple PUSCHs; the target PUSCH depends on reference information corresponding to the multiple PUSCHs, and the reference information comprises at least one of a coresetPoolIndex, an MCS index, or a frequency-domain resource allocation; herein, each PUSCH among the multiple PUSCHs is scheduled by one of the at least one signaling.

In one subembodiment of the above embodiment, the first communication device 410 corresponds to the second node in the present application.

In one embodiment, the first communication device 410 comprises a memory that stores a computer readable instruction program. The computer readable instruction program generates an action when executed by at least one processor. The action includes: transmitting at least one signaling; receiving a first UCI on a target PUSCH, the target PUSCH being one of multiple PUSCHs; the target PUSCH depending on reference information corresponding to the multiple PUSCHs, the reference information comprising at least one of a coresetPoolIndex, an MCS index, or a frequency-domain resource allocation; herein, each PUSCH among the multiple PUSCHs is scheduled by one of the at least one signaling.

In one subembodiment of the above embodiment, the first communication device 410 corresponds to the second node in the present application.

In one embodiment, at least one of the antenna 452, the receiver 454, the multi-antenna receiving processor 458, the receiving processor 456, the controller/processor 459, the memory 460, or the data source 467 is used to receive the at least one signaling in the present application.

In one embodiment, at least one of the antenna 420, the transmitter 418, the multi-antenna transmitting processor 471, the transmitting processor 416, the controller/processor 475, or the memory 476 is used to transmit the at least one signaling in the present application.

In one embodiment, at least one of the antenna 452, the receiver 454, the multi-antenna receiving processor 458, the receiving processor 456, the controller/processor 459, the memory 460 or the data source 467 is used to receive the first PDSCH in the present application.

In one embodiment, at least one of the antenna 420, the transmitter 418, the multi-antenna transmitting processor 471, the transmitting processor 416, the controller/processor 475 or the memory 476 is used to transmit the first PDSCH in the present application.

In one embodiment, at least one of the antenna 452, the transmitter 454, the multi-antenna transmission processor 458, the transmitting processor 468, the controller/processor 459, the memory 460, or the data source 467 is used to the first UCI in the present application on the target PUSCH in the present application.

In one embodiment, at least one of the antenna 420, the receiver 418, the multi-antenna receiving processor 472, the receiving processor 470, the controller/processor 475, or the memory 476 is used to receive the first UCI in the present application on the target PUSCH in the present application.

In one embodiment, the second communication device 450 comprises at least one processor and at least one memory. The at least one memory comprises computer program codes; the at least one memory and the computer program codes are configured to be used in collaboration with the at least one processor. The second communication device 450 at least: receives at least one signaling; transmits a first UCI on a target PUSCH, the target PUSCH is one of multiple PUSCHs; when one of the multiple PUSCHs is used for multiplexing an aperiodic CSI, the target PUSCH is the PUSCH used for multiplexing an aperiodic CSI; when the multiple PUSCHs are not used for multiplexing an aperiodic CSI, the target PUSCH depends on reference information corresponding to the multiple PUSCHs, and the reference information comprises at least one of a coresetPoolIndex, an MCS index, or a frequency-domain resource allocation; herein, each PUSCH among the multiple PUSCHs is scheduled by one of the at least one signaling.

In one subembodiment of the above embodiment, the second communication device 450 corresponds to the first node in the present application.

In one embodiment, the second communication device 450 comprises a memory that stores a computer readable instruction program. The computer readable instruction program generates an action when executed by at least one processor. The action includes: receiving at least one signaling; transmitting a first UCI on a target PUSCH, the target PUSCH being one of multiple PUSCHs; when one of the multiple PUSCHs is used for multiplexing an aperiodic CSI, the target PUSCH being the PUSCH used for multiplexing an aperiodic CSI; when the multiple PUSCHs are not used for multiplexing an aperiodic CSI, the target PUSCH depending on reference information corresponding to the multiple PUSCHs, the reference information comprising at least one of a coresetPoolIndex, an MCS index, or a frequency-domain resource allocation; herein, each PUSCH among the multiple PUSCHs is scheduled by one of the at least one signaling.

In one subembodiment of the above embodiment, the second communication device 450 corresponds to the first node in the present application.

In one embodiment, the first communication device 410 comprises at least one processor and at least one memory. The at least one memory comprises computer program codes; the at least one memory and the computer program codes are configured to be used in collaboration with the at least one processor. The first communication device 410 at least: transmits at least one signaling; receives a first UCI on a target PUSCH, the target PUSCH is one of multiple PUSCHs; when one of the multiple PUSCHs is used for multiplexing an aperiodic CSI, the target PUSCH is the PUSCH used for multiplexing an aperiodic CSI; when the multiple PUSCHs are not used for multiplexing an aperiodic CSI, the target PUSCH depends on reference information corresponding to the multiple PUSCHs, and the reference information comprises at least one of a coresetPoolIndex, an MCS index, or a frequency-domain resource allocation; herein, each PUSCH among the multiple PUSCHs is scheduled by one of the at least one signaling.

In one subembodiment of the above embodiment, the first communication device 410 corresponds to the second node in the present application.

In one embodiment, the first communication device 410 comprises a memory that stores a computer readable instruction program. The computer readable instruction program generates an action when executed by at least one processor. The action includes: transmitting at least one signaling; receiving a first UCI on a target PUSCH, the target PUSCH being one of multiple PUSCHs; when one of the multiple PUSCHs is used for multiplexing an aperiodic CSI, the target PUSCH being the PUSCH used for multiplexing an aperiodic CSI; when the multiple PUSCHs are not used for multiplexing an aperiodic CSI, the target PUSCH depending on reference information corresponding to the multiple PUSCHs, the reference information comprising at least one of a coresetPoolIndex, an MCS index, or a frequency-domain resource allocation; herein, each PUSCH among the multiple PUSCHs is scheduled by one of the at least one signaling.

In one subembodiment of the above embodiment, the first communication device 410 corresponds to the second node in the present application.

### Embodiment 5

Embodiment 5 illustrates a flowchart of signal transmission according to one embodiment in the present application, as shown in FIG. 5. In FIG. 5, a first node U1 and a second node U2 are in communications via an air interface.

The first node U1 receives at least one signaling in step S511; transmits a first UCI on a target PUSCH in step S512.

The second node U2 transmits at least one signaling in step S521; receives a first UCI on a target PUSCH in step S522.

In embodiment 5, the target PUSCH is one of multiple PUSCHs; when none of the multiple PUSCHs are used to multiplex an aperiodic CSI, the target PUSCH depends on a coresetPoolIndex corresponding to the multiple PUSCHs; each PUSCH among the multiple PUSCHs is scheduled by one of the at least one signaling.

In one subembodiment of embodiment 5, when one of the multiple PUSCHs is used for multiplexing an aperiodic CSI, the target PUSCH is the PUSCH used for multiplexing an aperiodic CSI.

In one subembodiment of embodiment 5, there exists at least one PUSCH corresponding to a coresetPoolIndex with a value of 0 and there exists at least one PUSCH corresponding to a coresetPoolIndex with a value of 1 among the multiple PUSCHs; when the multiple PUSCHs are not used to multiplex an aperiodic CSI, the target PUSCH is a PUSCH corresponding to a coresetPoolIndex with a value of 0 among the multiple PUSCHs.

In one subembodiment of embodiment 5, there exists at least one PUSCH corresponding to a coresetPoolIndex with a value of 0 and there exists at least one PUSCH corresponding to a coresetPoolIndex with a value of 1 among the multiple PUSCHs; when the multiple PUSCHs are not used to multiplex an aperiodic CSI, the target PUSCH is a PUSCH corresponding to a coresetPoolIndex with a value of 1 among the multiple PUSCHs.

In one subembodiment of embodiment 5, there exists at least one PUSCH corresponding to a coresetPoolIndex with a value of 0 and there exists at least one PUSCH corresponding to a coresetPoolIndex with a value of 1 among the multiple PUSCHs; when the multiple PUSCHs are not used for multiplexing an aperiodic CSI, the target PUSCH is a PUSCH corresponding to a coresetPoolIndex with a value of k among the multiple PUSCHs, where k is a value of a coresetPoolIndex corresponding to a first PUCCH, and k is one of 0 or 1.

In one embodiment, the first node U2 is the first node in the present application.

In one embodiment, the second node U2 is the second node in the present application.

In one embodiment, the first node U1 is a UE.

In one embodiment, the first node U1 is a base station.

In one embodiment, the second node U2 is a base station.

In one embodiment, the second node U2 is a UE.

In one embodiment, an air interface between the second node U2 and the first node U1 is a Uu interface.

In one embodiment, an air interface between the second node U2 and the first node U1 comprises a cellular link.

In one embodiment, an air interface between the second node U2 and the first node U1 is a PC5 interface.

In one embodiment, an air interface between the second node U2 and the first node U1 comprises a sidelink.

In one embodiment, an air interface between the second node U2 and the first node U1 comprises a radio interface between a base station and a UE.

In one embodiment, an air interface between the second node U2 and the first node U1 comprises a radio interface between a satellite and a UE.

In one embodiment, an air interface between the second node U2 and the first node U1 comprises a radio interface between UEs.

In one embodiment, the target PUSCH is: a PUSCH used for multiplexing the first UCI.

In one embodiment, when the first UCI is multiplexed into a PUSCH, the PUSCH is used for multiplexing a PUSCH of the first UCI.

In one embodiment, the target PUSCH is related to an aperiodic CSI.

In one embodiment, the target PUSCH is related to the multiplexing of an aperiodic CSI.

In one embodiment, the meaning of a PUSCH being used for multiplexing an aperiodic CSI is: an aperiodic CSI is multiplexed into the PUSCH.

In one embodiment, the meaning of a PUSCH not being used for multiplexing an aperiodic CSI is: an aperiodic CSI is not multiplexed into the PUSCH.

In one embodiment, the meaning of the expression in the present application that the multiple PUSCHs are not used for multiplexing an aperiodic CSI is: an aperiodic CSI is not multiplexed into any of the multiple PUSCHs.

In one embodiment, a problem to be solved in the present application comprises: how to determine the target PUSCH.

In one embodiment, a problem to be solved in the present application comprises: how to determine onto which PUSCH the first UCI is multiplexed.

In one embodiment, a problem to be solved in the present application comprises: how to improve the uplink transmission performance.

In one embodiment, a problem to be solved in the present application comprises: how to improve the transmission reliability of UCI.

In one embodiment, a problem to be solved in the present application comprises: how to improve system resource utilization.

In one embodiment, a problem to be solved in the present application comprises: how to improve scheduling flexibility.

### Embodiment 6

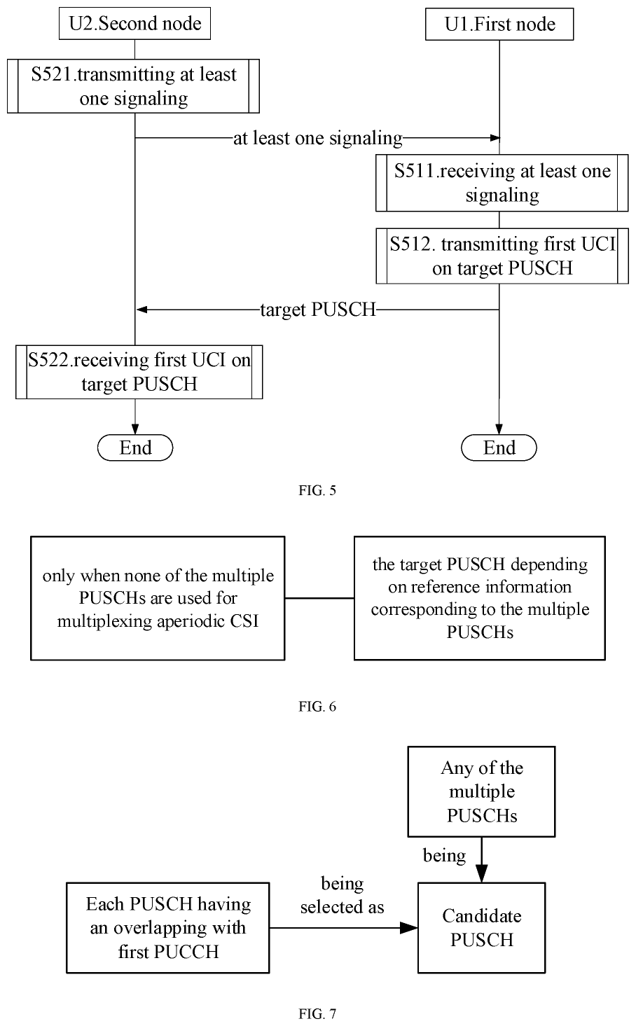

Embodiment 6 illustrates a schematic diagram of a target PUSCH according to one embodiment of the present application, as shown in FIG. 6.

In embodiment 6, only when none of the multiple PUSCHs are used to multiplex an aperiodic CSI, the target PUSCH depends on reference information corresponding to the multiple PUSCHs.

In one embodiment, when an aperiodic CSI is multiplexed onto one of the multiple PUSCHs, which of the multiple PUSCHs the target PUSCH is is not dependent on the reference information corresponding to the multiple PUSCHs.

In one embodiment, when an aperiodic CSI is multiplexed onto one of the multiple PUSCHs, which of the multiple PUSCHs the target PUSCH is is unrelated to the reference information corresponding to the multiple PUSCHs.

In one embodiment, when an aperiodic CSI is multiplexed onto one of the multiple PUSCHs, the target PUSCH is a PUSCH used to multiplex an aperiodic CSI among the multiple PUSCHs.

In one embodiment, the first node does not expect each of the multiple PUSCHs to comprise an aperiodic CSI report.

In one embodiment, the first node does not expect more than one PUSCH comprising an aperiodic CSI report to be present in the multiple PUSCHs.

### Embodiment 7

Embodiment 7 illustrates a schematic diagram of multiple PUSCHs according to one embodiment of the present application, as shown in FIG. 7.

In embodiment 7, each PUSCH that overlaps with a first PUCCH is selected as a candidate PUSCH, and any of the multiple PUSCHs is the candidate PUSCH, and the first PUCCH carries a UCI.

### Embodiment 8

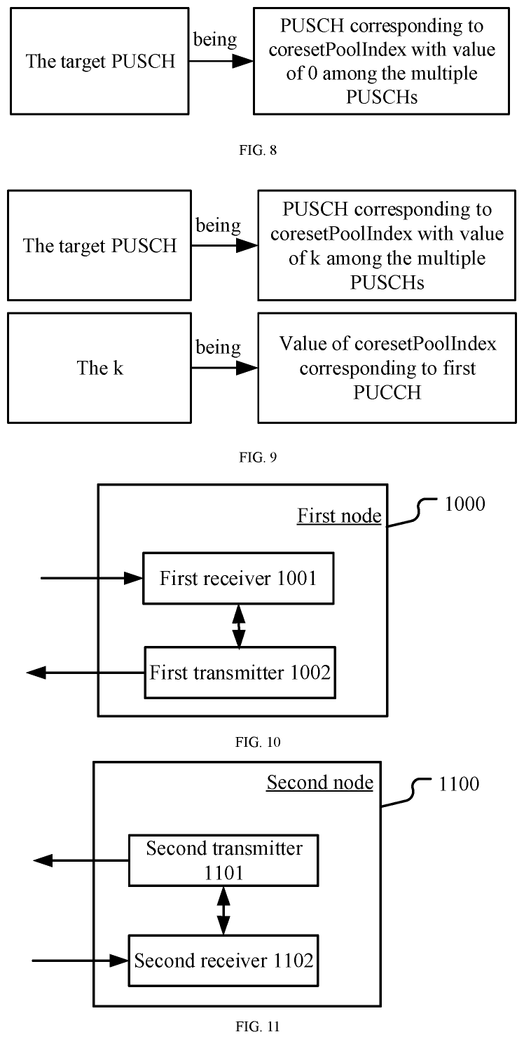

Embodiment 8 illustrates a schematic diagram of a target PUSCH according to one embodiment of the present application, as shown in FIG. 8.

In embodiment 8, the target PUSCH is a PUSCH corresponding to a coresetPoolIndex with a value of 0 among the multiple PUSCHs.

In one embodiment, a coresetPoolIndex corresponding to one of the multiple PUSCHs is: a coresetPoolIndex for a CORESET associated with a PDCCH scheduling the PUSCH.

In one embodiment, a coresetPoolIndex corresponding to one of the multiple PUSCHs is: a coresetPoolIndex configured in an information element ControlResourceSet for a CORESET of a PDCCH used to monitor and schedule the PUSCH.

In one embodiment, a coresetPoolIndex corresponding to one of the multiple PUSCHs is: a coresetPoolIndex configured in an information element ControlResourceSet for a CORESET of a DCI/DCI format used to monitor and schedule the PUSCH.

In one embodiment, a coresetPoolIndex corresponding to a PUSCH among the multiple PUSCHs is: a coresetPoolIndex associated with this PUSCH.

In one embodiment, there exists at least one PUSCH corresponding to a coresetPoolIndex with a value of 0 and there exists at least one PUSCH corresponding to a coresetPoolIndex with a value of 1 among the multiple PUSCHs, and the target PUSCH is a PUSCH corresponding to a coresetPoolIndex with a value of 1 among the multiple PUSCHs.

In one embodiment, there exists at least one PUSCH corresponding to a coresetPoolIndex with a value of 0 and there exists at least one PUSCH corresponding to a coresetPoolIndex with a value of 1 among the multiple PUSCHs.

In one embodiment, there exists only one PUSCH corresponding to a coresetPoolIndex with a value of 0 among the multiple PUSCHs.

In one embodiment, there exists more than one PUSCH corresponding to a coresetPoolIndex with a value of 0 among the multiple PUSCHs.

In one embodiment, there exists only one PUSCH corresponding to a coresetPoolIndex with a value of 1 among multiple PUSCHs.

In one embodiment, there exist more than one PUSCH corresponding to a coresetPoolIndex with a value of 1 among multiple PUSCHs.

In one embodiment, the target PUSCH is a PUSCH corresponding to a coresetPoolIndex with a value of 0 among the multiple PUSCHs.

In one embodiment, the target PUSCH is a PUSCH corresponding to a coresetPoolIndex with a value of 1 among the multiple PUSCHs.

### Embodiment 9

Embodiment 9 illustrates a schematic diagram of a target PUSCH according to one embodiment of the present application, as shown in FIG. 9.

In embodiment 9, the target PUSCH is a PUSCH corresponding to a coresetPoolIndex with a value of k among the multiple PUSCHs, where k is a value of a coresetPoolIndex corresponding to a first PUCCH, and k is one of 0 or 1.

In one embodiment, the first PUCCH overlaps with the multiple PUSCHs.

In one embodiment, the first PUCCH is a PUCCH reserved for at least a transmission of the first UCI.

In one embodiment, the first PUCCH is a PUCCH that bears a UCI.

In one embodiment, the first PUCCH is a PUCCH that bears the first UCI.

In one embodiment, the first PUCCH is a PUCCH would be transmitted.

In one embodiment, the coresetPoolIndex corresponding to the first PUCCH is: a coresetPoolIndex for a CORESET associated with a PDCCH that triggers a transmission of the first PUCCH

In one embodiment, the coresetPoolIndex corresponding to the first PUCCH is: a coresetPoolIndex for a CORESET associated with a DCI/DCI format that triggers a transmission of the first PUCCH.

In one embodiment, there exists at least one PUSCH corresponding to a coresetPoolIndex with a value of 0 and there exists at least one PUSCH corresponding to a coresetPoolIndex with a value of 1 among the multiple PUSCHs.

In one embodiment, the target PUSCH is a PUSCH corresponding to a coresetPoolIndex with a value of k among the multiple PUSCHs, where k is a value of a coresetPoolIndex corresponding to a first PUCCH, and k is one of 0 or 1.

In one embodiment, the target PUSCH is a PUSCH corresponding to a coresetPoolIndex with a value of k among the multiple PUSCHs, where k is a value of a coresetPoolIndex corresponding to a first PUCCH resource, and k is one of 0 or 1.

In one embodiment, there exists at least one PUSCH corresponding to a coresetPoolIndex with a value of 0 and there exists at least one PUSCH corresponding to a coresetPoolIndex with a value of 1 among the multiple PUSCHs, the target PUSCH is a PUSCH corresponding to a coresetPoolIndex with a value of k among the multiple PUSCHs, and k is a value of a coresetPoolIndex corresponding to a first PUCCH resource, k is one of 0 or 1.

In one embodiment, the first PUCCH resource is reserved for a transmission of a PUCCH.

In one embodiment, the first PUCCH resource is indicated by a DCI/DCI format.

In one embodiment, the first PUCCH resource overlaps with multiple PUSCHs.

### Embodiment 10

Embodiment 10 illustrates a structural block diagram of a processor in a first node, as shown in FIG. 10. In FIG. 10, a processor 1000 in a first node comprises a first receiver 1001 and a first transmitter 1002.

In one embodiment, the first node 1000 is a base station.

In one embodiment, the first node 1000 is a UE.

In one embodiment, the first node 1000 is a relay node.

In one embodiment, the first node 1000 is a vehicle-mounted communication device.

In one embodiment, the first node 1000 is a UE that supports V2X communications.

In one embodiment, the first node 1000 is a relay node that supports V2X communications.

In one embodiment, the first node 1000 is a UE that supports operations on high-frequency spectrum.

In one embodiment, the first node 1000 is a UE that supports operations on shared frequency spectrum.

In one embodiment, the first node 1000 is a UE that supports XR services.

In one embodiment, the first node 1000 is a UE that supports multicast transmission.

In one embodiment, the first receiver 1001 comprises at least one of the antenna 452, the receiver 454, the multi-antenna receiving processor 458, the receiving processor 456, the controller/processor 459, the memory 460 or the data source 467 in FIG. 4 of the present application.

In one embodiment, the first receiver 1001 comprises at least the first five of the antenna 452, the receiver 454, the multi-antenna receiving processor 458, the receiving processor 456, the controller/processor 459, the memory 460 and the data source 467 in FIG. 4 of the present application.

In one embodiment, the first receiver 1001 comprises at least the first four of the antenna 452, the receiver 454, the multi-antenna receiving processor 458, the receiving processor 456, the controller/processor 459, the memory 460 and the data source 467 in FIG. 4 of the present application.

In one embodiment, the first receiver 1001 comprises at least the first three of the antenna 452, the receiver 454, the multi-antenna receiving processor 458, the receiving processor 456, the controller/processor 459, the memory 460 and the data source 467 in FIG. 4 of the present application.

In one embodiment, the first receiver 1001 comprises at least the first two of the antenna 452, the receiver 454, the multi-antenna receiving processor 458, the receiving processor 456, the controller/processor 459, the memory 460 and the data source 467 in FIG. 4 of the present application.

In one embodiment, the first transmitter 1002 comprises at least one of the antenna 452, the transmitter 454, the multi-antenna transmitting processor 457, the transmitting processor 468, the controller/processor 459, the memory 460, or the data source 467 in FIG. 4 of the present application.

In one embodiment, the first transmitter 1002 comprises at least the first five of the antenna 452, the transmitter 454, the multi-antenna transmitting processor 457, the transmitting processor 468, the controller/processor 459, the memory 460, and the data source 467 in FIG. 4 of the present application.

In one embodiment, the first transmitter 1002 comprises at least the first four of the antenna 452, the transmitter 454, the multi-antenna transmitting processor 457, the transmitting processor 468, the controller/processor 459, the memory 460, and the data source 467 in FIG. 4 of the present application.

In one embodiment, the first transmitter 1002 comprises at least the first three of the antenna 452, the transmitter 454, the multi-antenna transmitting processor 457, the transmitting processor 468, the controller/processor 459, the memory 460, and the data source 467 in FIG. 4 of the present application.

In one embodiment, the first transmitter 1002 comprises at least the first two of the antenna 452, the transmitter 454, the multi-antenna transmitting processor 457, the transmitting processor 468, the controller/processor 459, the memory 460, and the data source 467 in FIG. 4 of the present application.

In one embodiment, the first receiver 1001 receives at least one signaling; the first transmitter 1002 transmits a first UCI on a target PUSCH, and the target PUSCH is one of multiple PUSCHs; the target PUSCH depends on reference information corresponding to the multiple PUSCHs, and the reference information comprises at least one of a coresetPoolIndex, an MCS index, or a frequency-domain resource allocation; herein, each PUSCH among the multiple PUSCHs is scheduled by one of the at least one signaling.

In one embodiment, only when none of the multiple PUSCHs are used to multiplex an aperiodic CSI, the target PUSCH depends on reference information corresponding to the multiple PUSCHs.

In one embodiment, all PUSCHs that have an overlapping with a PUCCH (Physical uplink control channel) carrying a UCI are selected as candidate PUSCHs, and any of the multiple PUSCHs is the candidate PUSCH.

In one embodiment, there exists at least one PUSCH corresponding to a coresetPoolIndex with a value of 0 and there exists at least one PUSCH corresponding to a coresetPoolIndex with a value of 1 among the multiple PUSCHs, and the target PUSCH is a PUSCH corresponding to a coresetPoolIndex with a value of 0 among the multiple PUSCHs.

In one embodiment, there exists at least one PUSCH corresponding to a coresetPoolIndex with a value of 0 and there exists at least one PUSCH corresponding to a coresetPoolIndex with a value of 1 among the multiple PUSCHs, and the target PUSCH is a PUSCH corresponding to a coresetPoolIndex with a value of 1 among the multiple PUSCHs.

In one embodiment, there exists at least one PUSCH corresponding to a coresetPoolIndex with a value of 0 and there exists at least one PUSCH corresponding to a coresetPoolIndex with a value of 1 among the multiple PUSCHs, the target PUSCH is a PUSCH corresponding to a coresetPoolIndex with a value of k among the multiple PUSCHs, and k is a value of a coresetPoolIndex corresponding to a first PUCCH, k is one of 0 or 1.

In one embodiment, the target PUSCH is a PUSCH adopting a maximum MCS index among the multiple PUSCHs.

In one embodiment, the first receiver 1001 receives a first PDSCH (Physical downlink shared channel); herein, the first UCI comprises HARQ-ACK information for a transmission block in the first PDSCH.

In one embodiment, the first receiver 1001 receives at least one signaling; the first transmitter 1002 transmits a first UCI on a target PUSCH, and the target PUSCH is one of multiple PUSCHs; when one of the multiple PUSCHs is used for multiplexing an aperiodic CSI, the target PUSCH is the PUSCH used for multiplexing an aperiodic CSI; when the multiple PUSCHs are not used for multiplexing an aperiodic CSI, the target PUSCH depends on reference information corresponding to the multiple PUSCHs, and the reference information comprises at least one of a coresetPoolIndex, an MCS index, or a frequency-domain resource allocation; herein, each PUSCH among the multiple PUSCHs is scheduled by one of the at least one signaling.

In one embodiment, all PUSCHs overlapping with a PUCCH carrying a UCI are selected as candidate PUSCHs, and any of the multiple PUSCHs is the candidate PUSCH.

In one embodiment, there exists at least one PUSCH corresponding to a coresetPoolIndex with a value of 0 and there exists at least one PUSCH corresponding to a coresetPoolIndex with a value of 1 among the multiple PUSCHs; when the multiple PUSCHs are not used to multiplex an aperiodic CSI, the target PUSCH is a PUSCH corresponding to a coresetPoolIndex with a value of 0 among the multiple PUSCHs.

In one embodiment, there exists at least one PUSCH corresponding to a coresetPoolIndex with a value of 0 and there exists at least one PUSCH corresponding to a coresetPoolIndex with a value of 1 among the multiple PUSCHs; when the multiple PUSCHs are not used to multiplex an aperiodic CSI, the target PUSCH is a PUSCH corresponding to a coresetPoolIndex with a value of 1 among the multiple PUSCHs.

In one embodiment, there exists at least one PUSCH corresponding to a coresetPoolIndex with a value of 0 and there exists at least one PUSCH corresponding to a coresetPoolIndex with a value of 1 among the multiple PUSCHs; when the multiple PUSCHs are not used for multiplexing an aperiodic CSI, the target PUSCH is a PUSCH corresponding to a coresetPoolIndex with a value of k among the multiple PUSCHs, where k is a value of a coresetPoolIndex corresponding to a first PUCCH, and k is one of 0 or 1.

In one embodiment, when the multiple PUSCHs are not used for multiplexing an aperiodic CSI, the target PUSCH is a PUSCH that uses a maximum MCS index among the multiple PUSCHs.

In one embodiment, the first receiver 1001 receives a first PDSCH; herein, the first UCI comprises HARQ-ACK information for a transmission block in the first PDSCH.

### Embodiment 11

Embodiment 11 illustrates a structure block diagram of a processor in a second node, as shown in FIG. 11. In FIG. 11, a processor 1100 in a second node comprises a second transmitter 1101 and a second receiver 1102.

In one embodiment, the second node 1100 is a UE.

In one embodiment, the second node 1100 is a base station.

In one embodiment, the second node 1100 is satellite.

In one embodiment, the second node 1100 is a relay node.

In one embodiment, the second node 1100 is a vehicle-mounted communication device.

In one embodiment, the second node 1100 is a UE supporting V2X communications.

In one embodiment, the second node 1100 is a device that supports operations on high-frequency spectrum.

In one embodiment, the second node 1100 is a device that supports operations on a shared spectrum.

In one embodiment, the second node 1100 is a device that supports XR services.

In one embodiment, the second node 1100 is one of testing devices, testing equipment, and testing instruments.

In one embodiment, the second transmitter 1101 comprises at least one of the antenna 420, the transmitter 418, the multi-antenna transmitting processor 471, the transmitting processor 416, the controller/processor 475 or the memory 476 in FIG. 4 of the present application.

In one embodiment, the second transmitter 1101 comprises at least first five of the antenna 420, the transmitter 418, the multi-antenna transmitting processor 471, the transmitting processor 416, the controller/processor 475 and the memory 476 in FIG. 4 of the present application.

In one embodiment, the second transmitter 1101 comprises at least first four of the antenna 420, the transmitter 418, the multi-antenna transmitting processor 471, the transmitting processor 416, the controller/processor 475 and the memory 476 in FIG. 4 of the present application.

In one embodiment, the second transmitter 1101 comprises at least first three of the antenna 420, the transmitter 418, the multi-antenna transmitting processor 471, the transmitting processor 416, the controller/processor 475 and the memory 476 in FIG. 4 of the present application.

In one embodiment, the second transmitter 1101 comprises at least first two of the antenna 420, the transmitter 418, the multi-antenna transmitting processor 471, the transmitting processor 416, the controller/processor 475 and the memory 476 in FIG. 4 of the present application.

In one embodiment, the second receiver 1102 comprises at least one of the antenna 420, the receiver 418, the multi-antenna receiving processor 472, the receiving processor 470, the controller/processor 475 or the memory 476 in FIG. 4 of the present application.

In one embodiment, the second receiver 1102 comprises at least first five of the antenna 420, the receiver 418, the multi-antenna receiving processor 472, the receiving processor 470, the controller/processor 475 and the memory 476 in FIG. 4 of the present application.

In one embodiment, the second receiver 1102 comprises at least first four of the antenna 420, the receiver 418, the multi-antenna receiving processor 472, the receiving processor 470, the controller/processor 475 and the memory 476 in FIG. 4 of the present application.

In one embodiment, the second receiver 1102 comprises at least first three of the antenna 420, the receiver 418, the multi-antenna receiving processor 472, the receiving processor 470, the controller/processor 475 and the memory 476 in FIG. 4 of the present application.

In one embodiment, the second receiver 1102 comprises at least first two of the antenna 420, the receiver 418, the multi-antenna receiving processor 472, the receiving processor 470, the controller/processor 475 and the memory 476 in FIG. 4 of the present application.

In one embodiment, the second transmitter 1101 transmits at least one signaling; the second receiver 1102 receives a first UCI on a target PUSCH, and the target PUSCH is one of multiple PUSCHs; the target PUSCH depends on reference information corresponding to the multiple PUSCHs, and the reference information comprises at least one of a coresetPoolIndex, an MCS index, or a frequency-domain resource allocation; herein, each PUSCH among the multiple PUSCHs is scheduled by one of the at least one signaling.

In one embodiment, only when none of the multiple PUSCHs are used to multiplex an aperiodic CSI, the target PUSCH depends on reference information corresponding to the multiple PUSCHs.

In one embodiment, all PUSCHs overlapping with a PUCCH carrying a UCI are selected as candidate PUSCHs, and any of the multiple PUSCHs is the candidate PUSCH.

In one embodiment, there exists at least one PUSCH corresponding to a coresetPoolIndex with a value of 0 and there exists at least one PUSCH corresponding to a coresetPoolIndex with a value of 1 among the multiple PUSCHs, and the target PUSCH is a PUSCH corresponding to a coresetPoolIndex with a value of 0 among the multiple PUSCHs.

In one embodiment, there exists at least one PUSCH corresponding to a coresetPoolIndex with a value of 0 and there exists at least one PUSCH corresponding to a coresetPoolIndex with a value of 1 among the multiple PUSCHs, and the target PUSCH is a PUSCH corresponding to a coresetPoolIndex with a value of 1 among the multiple PUSCHs.

In one embodiment, there exists at least one PUSCH corresponding to a coresetPoolIndex with a value of 0 and there exists at least one PUSCH corresponding to a coresetPoolIndex with a value of 1 among the multiple PUSCHs, the target PUSCH is a PUSCH corresponding to a coresetPoolIndex with a value of k among the multiple PUSCHs, and k is a value of a coresetPoolIndex corresponding to a first PUCCH, k is one of 0 or 1.

In one embodiment, the target PUSCH is a PUSCH adopting a maximum MCS index among the multiple PUSCHs.

In one embodiment, the second transmitter 1101 transmits a first PDSCH; herein, the first UCI comprises HARQ-ACK information for a transmission block in the first PDSCH.

In one embodiment, the second transmitter 1101 transmits at least one signaling; the second receiver 1102 receives a first UCI on a target PUSCH, and the target PUSCH is one of multiple PUSCHs; when one of the multiple PUSCHs is used for multiplexing an aperiodic CSI, the target PUSCH is the PUSCH used for multiplexing an aperiodic CSI; when the multiple PUSCHs are not used for multiplexing an aperiodic CSI, the target PUSCH depends on reference information corresponding to the multiple PUSCHs, and the reference information comprises at least one of a coresetPoolIndex, an MCS index, or a frequency-domain resource allocation; herein, each PUSCH among the multiple PUSCHs is scheduled by one of the at least one signaling.

In one embodiment, all PUSCHs overlapping with a PUCCH carrying a UCI are selected as candidate PUSCHs, and any of the multiple PUSCHs is the candidate PUSCH.

In one embodiment, there exists at least one PUSCH corresponding to a coresetPoolIndex with a value of 0 and there exists at least one PUSCH corresponding to a coresetPoolIndex with a value of 1 among the multiple PUSCHs; when the multiple PUSCHs are not used to multiplex an aperiodic CSI, the target PUSCH is a PUSCH corresponding to a coresetPoolIndex with a value of 0 among the multiple PUSCHs.

In one embodiment, there exists at least one PUSCH corresponding to a coresetPoolIndex with a value of 0 and there exists at least one PUSCH corresponding to a coresetPoolIndex with a value of 1 among the multiple PUSCHs; when the multiple PUSCHs are not used to multiplex an aperiodic CSI, the target PUSCH is a PUSCH corresponding to a coresetPoolIndex with a value of 1 among the multiple PUSCHs.

In one embodiment, there exists at least one PUSCH corresponding to a coresetPoolIndex with a value of 0 and there exists at least one PUSCH corresponding to a coresetPoolIndex with a value of 1 among the multiple PUSCHs; when the multiple PUSCHs are not used for multiplexing an aperiodic CSI, the target PUSCH is a PUSCH corresponding to a coresetPoolIndex with a value of k among the multiple PUSCHs, where k is a value of a coresetPoolIndex corresponding to a first PUCCH, and k is one of 0 or 1.

In one embodiment, when the multiple PUSCHs are not used for multiplexing an aperiodic CSI, the target PUSCH is a PUSCH that uses a maximum MCS index among the multiple PUSCHs.

In one embodiment, the second transmitter 1101 transmits a first PDSCH; herein, the first UCI comprises HARQ-ACK information for a transmission block in the first PDSCH.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The first node in the present application includes but is not limited to mobile phones, tablet computers, notebooks, network cards, low-consumption equipment, enhanced MTC (eMTC) terminals, NB-IOT terminals, vehicle-mounted communication equipment, aircrafts, diminutive airplanes, unmanned aerial vehicles, telecontrolled aircrafts and other wireless communication devices. The second node in the present application includes but is not limited to mobile phones, tablet computers, notebooks, network cards, low-consumption equipment, enhanced MTC (eMTC) terminals, NB-IOT terminals, vehicle-mounted communication equipment, aircrafts, diminutive airplanes, unmanned aerial vehicles, telecontrolled aircrafts and other wireless communication devices. The UE or terminal in the present application includes but is not limited to mobile phones, tablet computers, notebooks, network cards, low-consumption equipment, enhanced MTC (eMTC) terminals, NB-IOT terminals, vehicle-mounted communication equipment, aircrafts, diminutive airplanes, unmanned aerial vehicles, telecontrolled aircrafts, etc. The base station or network side equipment in the present application includes but is not limited to macro-cellular base stations, micro-cellular base stations, home base stations, relay base station, eNB, gNB, Transmitter Receiver Point (TRP), GNSS, relay satellites, satellite base stations, space base stations, test device, test equipment, test instrument and other radio communication equipment.

It will be appreciated by those skilled in the art that this disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, receiving at least one signaling; and
a first transmitter, transmitting a first UCI on a target PUSCH, the target PUSCH being one of multiple PUSCHs; each PUSCH among the multiple PUSCHs being scheduled by one of the at least one signaling; the first UCI comprising HARQ-ACK information;
wherein the target PUSCH depends on reference information corresponding to the multiple PUSCHs, and the reference information comprises at least one of a coresetPoolIndex, an MCS index, or a frequency-domain resource allocation; there exists at least one PUSCH corresponding to a coresetPoolIndex with a value of 0 and there exists at least one PUSCH corresponding to a coresetPoolIndex with a value of 1 among the multiple PUSCHs, the target PUSCH is a PUSCH corresponding to a coresetPoolIndex with a value of k among the multiple PUSCHs, and k is a value of a coresetPoolIndex corresponding to a first PUCCH, k is one of 0 or 1; the first PUCCH is overlapping with the multiple PUSCHs, and the first PUCCH is a PUCCH carrying the first UCI.

2. The first node according to claim 1, wherein only when none of the multiple PUSCHs are used to multiplex an aperiodic CSI, the target PUSCH depends on reference information corresponding to the multiple PUSCHs.

3. The first node according to claim 1, wherein all PUSCHs overlapping with a PUCCH carrying a UCI are selected as candidate PUSCHs, and any of the multiple PUSCHs is the candidate PUSCH.

4. The first node according to claim 1, wherein each signaling in the at least one signaling is a DCI format.

5. The first node according to claim 1, wherein for any of the multiple PUSCHs, the corresponding reference information is a coresetPoolIndex.

6. A second node for wireless communications, comprising:
a second transmitter, transmitting at least one signaling; and
a second receiver, receiving a first UCI on a target PUSCH, the target PUSCH being one of multiple PUSCHs; each PUSCH among the multiple PUSCHs being scheduled by one of the at least one signaling; the first UCI comprising HARQ-ACK information;
wherein the target PUSCH depends on reference information corresponding to the multiple PUSCHs, and the reference information comprises at least one of a coresetPoolIndex, an MCS index, or a frequency-domain resource allocation; there exists at least one PUSCH corresponding to a coresetPoolIndex with a value of 0 and there exists at least one PUSCH corresponding to a coresetPoolIndex with a value of 1 among the multiple PUSCHs, the target PUSCH is a PUSCH corresponding to a coresetPoolIndex with a value of k among the multiple PUSCHs, and k is a value of a coresetPoolIndex corresponding to a first PUCCH, k is one of 0 or 1; the first PUCCH is overlapping with the multiple PUSCHs, and the first PUCCH is a PUCCH carrying the first UCI.

7. The second node according to claim 6, wherein only when none of the multiple PUSCHs are used to multiplex an aperiodic CSI, the target PUSCH depends on reference information corresponding to the multiple PUSCHs.

8. The second node according to claim 6, wherein all PUSCHs overlapping with a PUCCH carrying a UCI are selected as candidate PUSCHs, and any of the multiple PUSCHs is the candidate PUSCH.

9. The second node according to claim 6, wherein each signaling in the at least one signaling is a DCI format.

10. The second node according to claim 6, wherein for any of the multiple PUSCHs, the corresponding reference information is a coresetPoolIndex.

11. A method in a first node for wireless communications, comprising:
receiving at least one signaling; and
transmitting a first UCI on a target PUSCH, the target PUSCH being one of multiple PUSCHs; each PUSCH among the multiple PUSCHs being scheduled by one of the at least one signaling; the first UCI comprising HARQ-ACK information;
wherein the target PUSCH depends on reference information corresponding to the multiple PUSCHs, and the reference information comprises at least one of a coresetPoolIndex, an MCS index, or a frequency-domain resource allocation; there exists at least one PUSCH corresponding to a coresetPoolIndex with a value of 0 and there exists at least one PUSCH corresponding to a coresetPoolIndex with a value of 1 among the multiple PUSCHs, the target PUSCH is a PUSCH corresponding to a coresetPoolIndex with a value of k among the multiple PUSCHs, and k is a value of a coresetPoolIndex corresponding to a first PUCCH, k is one of 0 or 1; the first PUCCH is overlapping with the multiple PUSCHs, and the first PUCCH is a PUCCH carrying the first UCI.

12. The method in a first node according to claim 11, wherein only when none of the multiple PUSCHs are used to multiplex an aperiodic CSI, the target PUSCH depends on reference information corresponding to the multiple PUSCHs.

13. The method in a first node according to claim 11, wherein all PUSCHs overlapping with a PUCCH carrying a UCI are selected as candidate PUSCHs, and any of the multiple PUSCHs is the candidate PUSCH.

14. The method in a first node according to claim 11, wherein each signaling in the at least one signaling is a DCI format.

15. The method in a first node according to claim 11, wherein for any of the multiple PUSCHs, the corresponding reference information is a coresetPoolIndex.

16. A method in a second node for wireless communications, comprising:
transmitting at least one signaling; and
receiving a first UCI on a target PUSCH, the target PUSCH being one of multiple PUSCHs; each PUSCH among the multiple PUSCHs being scheduled by one of the at least one signaling; the first UCI comprising HARQ-ACK information;
wherein the target PUSCH depends on reference information corresponding to the multiple PUSCHs, and the reference information comprises at least one of a coresetPoolIndex, an MCS index, or a frequency-domain resource allocation; there exists at least one PUSCH corresponding to a coresetPoolIndex with a value of 0 and there exists at least one PUSCH corresponding to a coresetPoolIndex with a value of 1 among the multiple PUSCHs, the target PUSCH is a PUSCH corresponding to a coresetPoolIndex with a value of k among the multiple PUSCHs, and k is a value of a coresetPoolIndex corresponding to a first PUCCH, k is one of 0 or 1; the first PUCCH is overlapping with the multiple PUSCHs, and the first PUCCH is a PUCCH carrying the first UCI.

17. The method in a second node according to claim 16, wherein only when none of the multiple PUSCHs are used to multiplex an aperiodic CSI, the target PUSCH depends on reference information corresponding to the multiple PUSCHs.

18. The method in a second node according to claim 16, wherein all PUSCHs overlapping with a PUCCH carrying a UCI are selected as candidate PUSCHs, and any of the multiple PUSCHs is the candidate PUSCH.

19. The method in a second node according to claim 16, wherein each signaling in the at least one signaling is a DCI format.

20. The method in a second node according to claim 16, wherein for any of the multiple PUSCHs, the corresponding reference information is a coresetPoolIndex.
